(19) United States
(12) Patent Application Publication
(10) Pub. No.: US 2014/0233645 A1
(43) Pub. Date: Aug. 21, 2014

(54) MOVING IMAGE ENCODING APPARATUS, METHOD OF CONTROLLING THE SAME, AND PROGRAM

(71) Applicant: CANON KABUSHIKI KAISHA, Tokyo (JP)

(72) Inventor: Daisuke Sakamoto, Yokohama-shi (JP)

(21) Appl. No.: 14/343,647

(22) PCT Filed: Nov. 7, 2012
(86) PCT No.: PCT/JP2012/079441

§ 371 Date: Mar. 7, 2014

(30) Foreign Application Priority Data
Nov. 28, 2011 (JP) 2011-259516

(51) Int. Cl. H04N 19/107

(52) U.S. Cl. CPC H04N 19/0003
USPC 375/240.13

(57) ABSTRACT

A moving image encoding apparatus for performing prediction encoding using inter prediction and intra prediction, comprising storage means for storing an encoding target image, reference image storage means for storing a reference image, decision means for deciding one of an inter prediction mode and an intra prediction mode as a prediction mode for a prediction target block, and encoding means for encoding the encoding target image including a block predicted in accordance with the decided prediction mode. The prediction mode decision means comprising pattern matching means for determining correlation between the encoding target image and the reference image. The prediction mode decision means selectively uses the pattern matching means when determining the correlation for the prediction target block by the inter prediction mode, and when determining the correlation for the prediction target block by intra template prediction.

### TECHNICAL FIELD

The present invention relates to a moving image encoding apparatus, a method of controlling the same, and a program.

### BACKGROUND ART

In recent years, digitization of information such as audio signals and video signals associated with so-called multimedia is rapidly proceeding. Accordingly, compression-encoding/decoding techniques for video signals have attracted attention. The compression-encoding/decoding techniques can reduce the storage capacity necessary for storing video signals or a band necessary for transmission and are therefore very important for the multimedia industry.

These compression-encoding/decoding techniques compress the information amount/data amount using the high autocorrelation (that is, redundancy) of many video signals. A video signal has temporal redundancy and two-dimensional spatial redundancy. The temporal redundancy can reduce the information amount using motion detection and motion compensation of each block. On the other hand, the spatial redundancy can reduce the information amount using DCT (Discrete Cosine Transformation).

Out of the encoding methods that use these techniques, H.264/MPEG-4 PART10 (AVC) (to be referred to as H.264 hereinafter) is supposed to have currently realized encoding of highest efficiency. One of the techniques introduced in this method is intra prediction that uses correlation in a frame and predicts pixel values in a single frame using intra-frame pixel values. In the intra prediction proposed in H.264, a plurality of intra prediction modes using encoded pixels adjacent to an encoding target block exist. A plurality of predicted images corresponding to the respective prediction modes are generated, and an appropriate intra prediction mode is selected.

In the intra prediction proposed in H.264, only pixels adjacent to the encoding target block are used. For this reason, it may be impossible to sufficiently consider the correlation in a frame, and the encoding efficiency may be low.

Japanese Patent Laid-Open No. 2010-16454 proposes a new intra prediction method in which pattern matching is performed between a template region formed from decoded pixels adjacent to an encoding target image and a predetermined decoded image region in the same frame, and a region having the highest correlation is employed as a predicted image. Note that in Japanese Patent Laid-Open No. 2010-16454, this intra prediction method is called intra template motion prediction (to be referred to as “intra TP motion prediction” hereinafter).

The intra TP motion prediction proposed in Japanese Patent Laid-Open No. 2010-16454 will be described with reference to FIG. 4.

Referring to FIG. 4, a 4×4 pixel encoding target block A and a predetermined search range E (x×y) formed from encoded pixels out of a region of X×Y (horizontal x vertical) pixels are shown on an encoding target frame. Each block a included in the block A is an encoding target subblock. The subblock a is located at the upper left position of the 2×2 pixel subblocks. A template region b formed from encoded pixels is adjacent to the subblock a. As shown in FIG. 4, the template region b is located on the left and upper sides of the subblock a.

In the intra TP motion prediction, pattern matching processing is performed within the predetermined search range E on the target frame using, for example, SAD (Sum of Absolute Difference) as the cost function. A region b′ having the highest correlation to the pixel values in the template region b is searched for. A block a′ corresponding to the found region b′ is used as a predicted image for the target subblock a.

In this way, a decoded image is used for pattern matching processing in search processing of intra TP motion prediction. Hence, when the predetermined search range E and the cost function are defined in advance, the same processing can be performed even at the time of decoding. That is, since no motion vector information is needed at the time of decoding, the amount of motion vector information in a stream can be reduced. Note that in Japanese Patent Laid-Open No. 2010-16454, a predetermined range is set about a position specified by predicted intra motion vectors generated from intra motion vectors obtained by intra TP motion prediction of peripheral blocks, and this range is used as the search range E.

As described above, the intra TP motion prediction is close to conventional inter prediction using motion vectors but is different in that the vector information need not be encoded because the method of determining the region having the highest correlation to the image region to be subjected to pattern matching is uniquely defined in advance.

The intra TP motion prediction proposed in Japanese Patent Laid-Open No. 2010-16454 achieves a high encoding efficiency by using not only the pixels adjacent to the encoding target block but also the predetermined decoded image region in the same frame.

However, to implement the intra TP motion prediction, a pattern matching circuit of a large circuit scale, like a circuit used in motion vector search of inter prediction, must be installed, which results in an increase in the circuit scale.

### SUMMARY OF INVENTION

The present invention implements intra TP motion prediction while suppressing an increase in the circuit scale.

In order to solve the above-described problems, according to the present invention, there is provided a moving image encoding apparatus for performing prediction encoding using inter prediction and intra prediction, comprising: storage means for storing an encoding target image; reference image storage means for storing a reference image for the prediction encoding; prediction mode decision means for deciding one of an inter prediction mode and an intra prediction mode as a prediction mode based on the encoding target image and the reference image; and encoding means for encoding the encoding target image motion-predicted in accordance with the prediction mode decided by the prediction mode decision means, the prediction mode decision means comprising pattern matching means for determining correlation between the encoding target image and the reference image, wherein the prediction mode decision means selectively uses the pattern matching means when executing motion prediction in the inter prediction mode and when executing intra template motion prediction including motion search processing out of the intra prediction mode.

Further features of the present invention will become apparent from the following description of exemplary embodiments (with reference to the attached drawings).

### BRIEF DESCRIPTION OF DRAWINGS

FIG. 1 is a block diagram showing an example of the arrangement of a moving image encoding apparatus according to the first embodiment;

FIG. 2 is a block diagram showing an example of the arrangement of a prediction mode decision unit according to the first embodiment;

FIG. 3 is a flowchart showing an example of the operation of the moving image encoding apparatus according to the first embodiment;

FIG. 4 is an explanatory view of the operation of intra TP motion prediction;

FIG. 5 is a block diagram showing an example of the arrangement of a moving image encoding apparatus according to the second embodiment; and

FIG. 6 is a block diagram showing an example of the arrangement of a moving image encoding apparatus according to the third embodiment.

### DESCRIPTION OF EMBODIMENTS

The present invention will now be described based on embodiments with reference to the accompanying drawings.

### First Embodiment

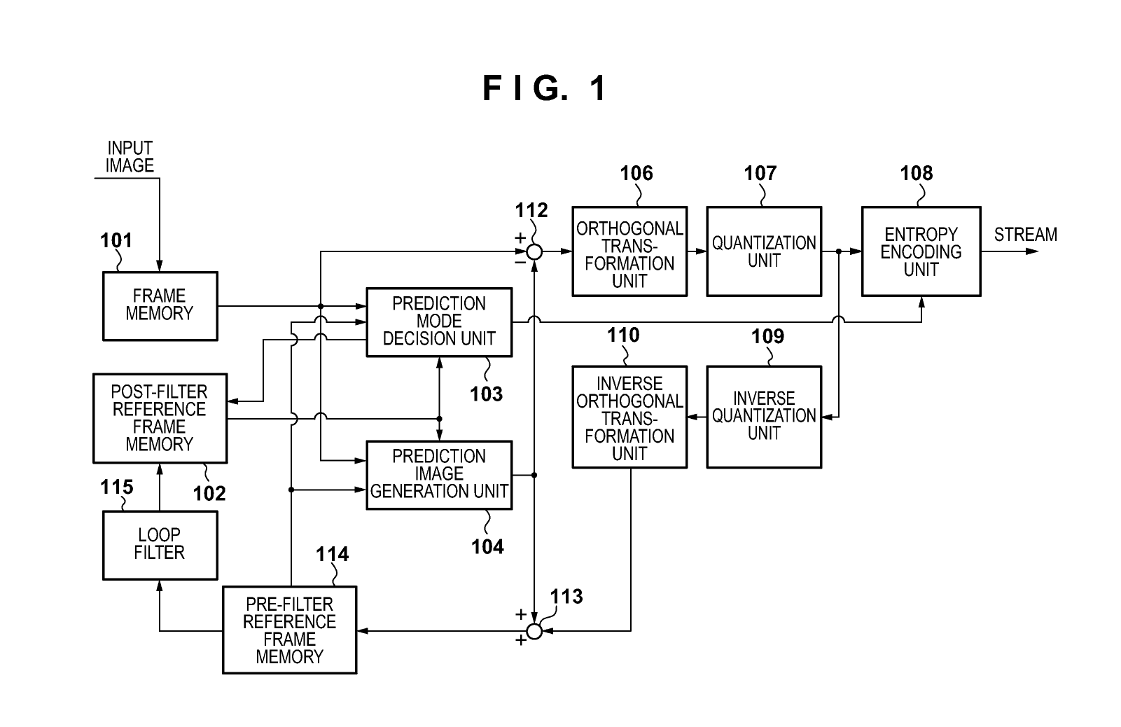

A moving image encoding apparatus according to an embodiment of the present invention will be described below in detail with reference to FIGS. 1 to 3.

FIG. 1 is a block diagram of a moving image encoding apparatus according to the present invention, which performs moving image prediction encoding by intra prediction and inter prediction. The moving image encoding apparatus includes a frame memory 101, a post-filter reference frame memory 102, a prediction mode decision unit 103, a predicted image generation unit 104, an orthogonal transformation unit 106, a quantization unit 107, an entropy encoding unit 108, an inverse quantization unit 109, an inverse orthogonal transformation unit 110, a subtracter 112, an adder 113, a pre-filter reference frame memory 114, and a loop filter 115.

In the moving image encoding apparatus shown in FIG. 1, the blocks may be formed as hardware using dedicated logic circuits and memories. Alternatively, the blocks may be implemented as software by causing a computer such as a CPU to execute processing programs stored in a memory.

An input image encoding method by the arrangement will be described below with reference to FIG. 1. An input image (original image) is stored in the frame memory 101 in the display order. An encoding target block that is an encoding target image is sequentially output to the prediction mode decision unit 103, the predicted image generation unit 104, and the subtracter 112 in the encoding order. The post-filter reference frame memory 102 is used to store a reference image, and stores an encoded image that has undergone filter processing as a reference image. The reference image of the encoding target block is sequentially output to the prediction mode decision unit 103 and the predicted image generation unit 104 in the encoding order. The subtracter 112 subtracts a predicted image block output from the predicted image generation unit 104 from the encoding target block output from the frame memory 101, and outputs image residual data. The orthogonal transformation unit 106 performs orthogonal transformation of the image residual data output from the subtracter 112, and outputs a conversion factor to the quantization unit 107.

The quantization unit 107 quantizes the conversion factor from the orthogonal transformation unit 106 using a predetermined quantization parameter, and outputs the conversion factor to the entropy encoding unit 108 and the inverse quantization unit 109. The entropy encoding unit 108 receives the conversion factor quantized by the quantization unit 107, performs entropy encoding such as CAVLC or CABAC, and outputs encoded data.

A method of generating reference image data using the conversion factor quantized by the quantization unit 107 will be described next. The inverse quantization unit 109 inversely quantizes the quantized conversion factor output from the quantization unit 107. The inverse orthogonal transformation unit 110 performs inverse orthogonal transformation of the conversion factor inversely quantized by the inverse quantization unit 109 to generate decoding residual data, and outputs it to the adder 113. The adder 113 adds the decoding residual data and predicted image data to be described later to generate reference image data, and stores it in the pre-filter reference frame memory 114. The reference image data is also output to the loop filter 115. The loop filter 115 filters the reference image data to remove noise, and stores the filtered reference image data in the post-filter reference frame memory 102.

A method of generating predicted image data using input image data, pre-filter reference image data, and post-filter reference image data will be described next. The prediction mode decision unit 103 decides the prediction mode of the encoding target block from the encoding target block output from the frame memory 101 and post-filter reference image data output from the post-filter reference frame memory 102. The decided prediction mode is output to the predicted image generation unit 104 together with a post-filter reference frame image data number. Note that the prediction mode decision method as the gist of the present invention will be described later in detail.

The predicted image generation unit 104 generates predicted image data. At this time, it is determined based on the prediction mode notified by the prediction mode decision unit 103 whether to refer to the reference frame image in the post-filter reference frame memory 102 or use the decoded pixels around the encoding target block output from the pre-filter reference frame memory 114. The generated predicted image data is output to the subtracter 112.

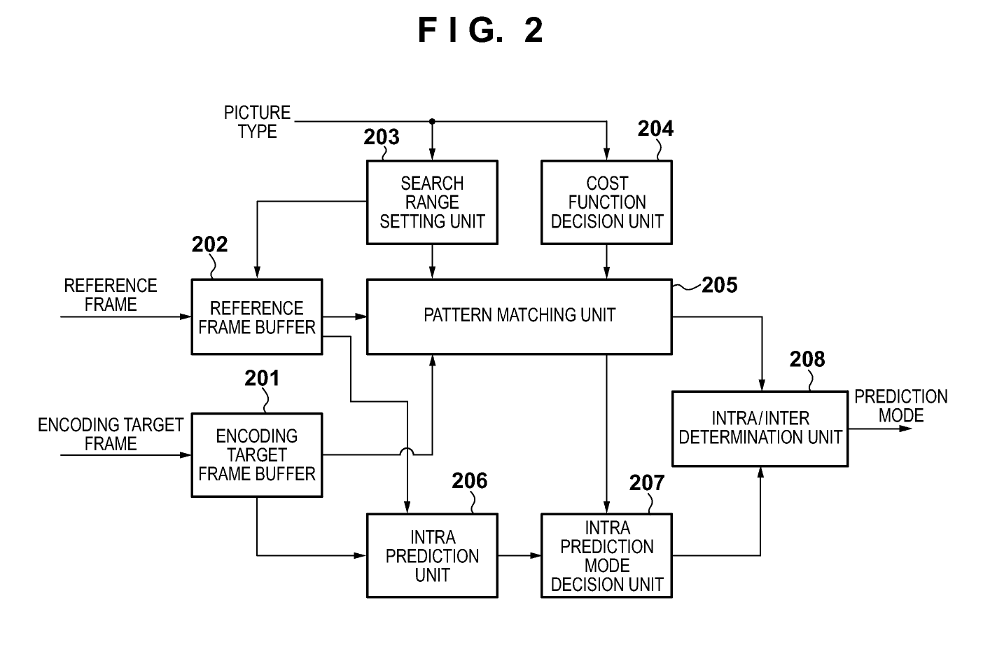

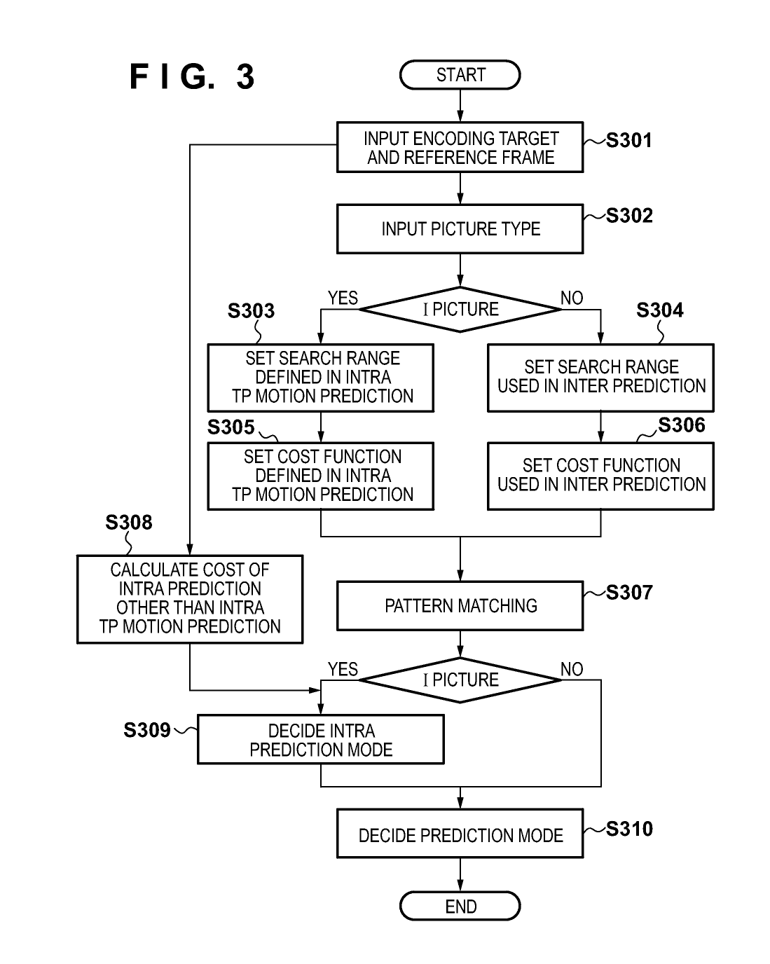

The prediction mode decision method of the prediction mode decision unit 103 according to the present invention will be described next with reference to the detailed block diagram of the prediction mode decision unit shown in FIG. 2 and the flowchart of FIG. 3. FIG. 2 is a block diagram of the prediction mode decision unit 103 according to the present invention.

The prediction mode decision unit 103 includes an encoding target frame buffer 201, a reference frame buffer 202, a search range setting unit 203, a cost function decision unit 204, a pattern matching unit 205, an intra prediction unit 206, an intra prediction mode decision unit 207, and an intra/inter determination unit 208.

In step S301, the encoding target frame buffer 201 reads out an encoding target block (to be referred to as a prediction target block) from the frame memory 101 shown in FIG. 1, stores the encoding target block, and outputs it to the pattern matching unit 205 and the intra prediction unit 206. Additionally, in step S301, the reference frame buffer 202 reads out a reference image based on a search range notified by the search range setting unit 203 to be described later from the post-filter reference frame memory 102 or the pre-filter reference frame memory 114 shown in FIG. 1, and stores the reference image. The image in the search range is output to the pattern matching unit 205 and the intra prediction unit 206. In step S302, the control unit (for example, CPU) of the moving image encoding apparatus inputs a picture type to the search range setting unit 203. The search range setting unit 203 sets a search range using the received picture type, and outputs it to the reference frame buffer 202. More specifically, if the picture type is I picture, the search range setting unit 203 sets a search range to be used in intra template motion prediction (intra TP motion prediction) in step S303. More specifically, the search range setting unit 203 sets a predetermined search range that is already encoded in the encoding target frame. The setting method may be the same as the method described in Japanese Patent Laid-Open No. 2010-16454. Alternatively, a predetermined range including encoded pixels around the encoding target block may be set. On the other hand, if the picture type is P picture or B picture, the search range setting unit 203 sets a search range to be used in the inter prediction mode in step S304. The search range setting method is based on the setting method in bidirectional prediction or forward prediction used in the general inter prediction mode, and a detailed description thereof will be omitted.

The reason why the search range is set in this way will be described below. For an I picture, inter prediction is not performed. Hence, the pattern matching unit 205 can be used unconditionally in intra TP motion prediction. On the other hand, for a P picture or B picture, the pattern matching unit 205 is used in a motion vector search of inter prediction. For this reason, the intra TP motion prediction cannot be selected as the prediction mode. However, for a P picture or B picture, inter prediction is basically selected as the prediction mode. In addition, even if the inter prediction is not selected, another intra prediction mode can be selected.

Hence, image quality is rarely affected even when the application purpose of the reference frame buffer 202 and the pattern matching unit 205 is switched in accordance with the picture type. In addition, when the search range is switched based on the picture type, the reference frame buffer 202 and the pattern matching unit 205 can be shared for the intra TP motion prediction and the inter prediction. This allows to largely reduce the circuit scale as compared to a case in which the circuits are separately implemented.

Next, the cost function decision unit 204 selects, in accordance with the picture type output from the control unit of the moving image encoding apparatus, a cost function to be used by the pattern matching unit 205 to be described later, and outputs the cost function to the pattern matching unit 205. For an I picture, the cost function decision unit 204 selects, in step S305, a first cost function to be used in the intra TP motion prediction. More specifically, the above-described SAD (Sum of Absolute Difference) of the prediction error or a cost function of performing Hadamard transformation for the prediction error and obtaining the sum of absolute values (SATD: Sum of Absolute Transform Difference) is usable. For a P or B picture, the cost function decision unit 204 selects, in step S306, a second cost function to be used in the inter prediction. More specifically,

Cost=SAD+QP×vector code amount (1)

which considers the code amount of motion vectors in addition to the above-described SAD or SATD can be used as the cost function. Note that QP is the quantization parameter.

In this embodiment, SAD and SATD have been exemplified as the cost function to be used in the intra TP motion prediction, and equation (1) has been exemplified as the cost function to be used in the inter prediction. However, the cost functions are not limited to those.

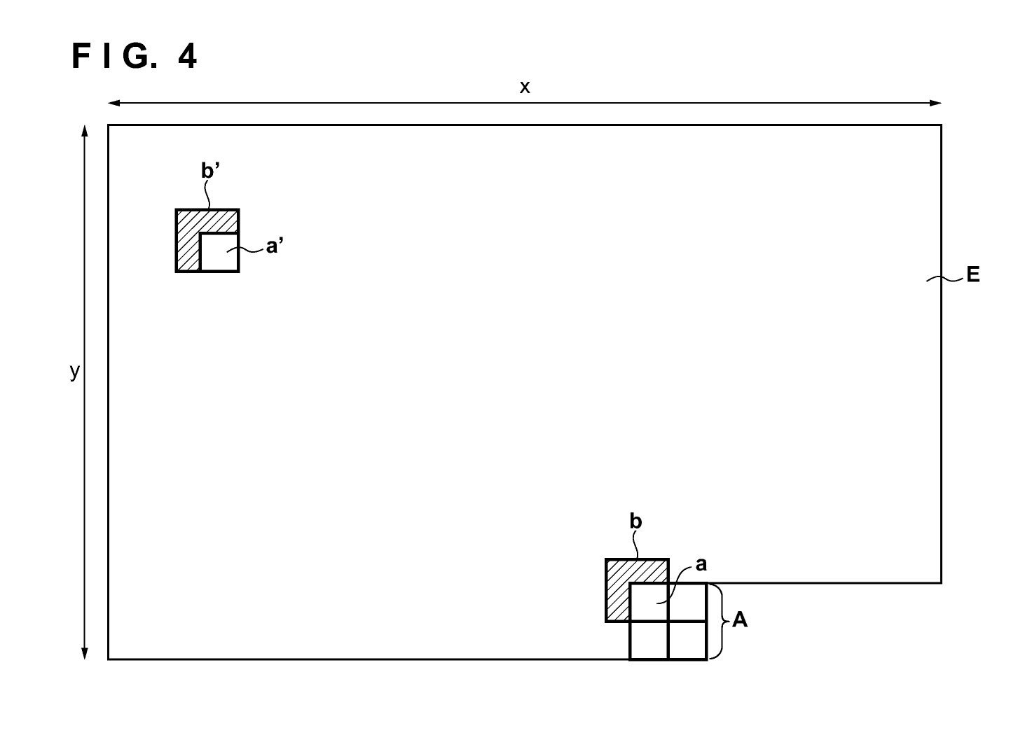

In step S307, the pattern matching unit 205 performs pattern matching processing in the search range designated by the search range setting unit 203 using the cost function decided by the cost function decision unit 204, and searches for a region having the highest correlation. That is, pattern matching processing is performed in the search range E shown in FIG. 4 using the SAD (Sum of Absolute Difference) as the cost function, and the region b′ having the highest correlation to the pixel values in the template region b formed from encoded pixels is searched for. A region where the cost function takes the smallest value is defined as the region having the highest correlation. In the intra TP motion prediction, the cost at that time is output to the intra prediction mode decision unit 207 as the best cost. In this embodiment, the “intra TP motion prediction” will also be referred to as a “first intra prediction mode” to discriminate it from the intra prediction mode predetermined in H.264 to be described later. That is, the pattern matching unit 205 calculates the minimum cost in the search range as the cost of the first intra prediction mode, and outputs it to the intra prediction mode decision unit 207. In the inter prediction, the cost function (in this embodiment, SAD or SATD) of the intra TP motion prediction in the best cost region is obtained and output to the intra/inter determination unit 208.

The intra prediction unit 206 reads out the encoding target block image from the encoding target frame buffer 201 and encoded pixels adjacent to the encoding target block from the reference frame buffer 202. In step S308, all intra predicted images except the image of intra TP motion prediction are generated as intra prediction candidates, and an intra prediction mode with a minimum cost function is selected using the same cost function as in the intra TP motion prediction. The selected intra prediction mode is output to the intra prediction mode decision unit 207 together with the cost. Note that the intra prediction described here is the intra prediction method including a plurality of intra prediction modes proposed in H.264. More specifically, intra 16×16 prediction that decides the prediction direction based on 16×16 pixel block data has four types of prediction directions. Intra 4×4 prediction that decides the prediction direction based on 4×4 pixel block data has nine types of prediction directions. The intra prediction unit 206 selects a mode of minimum cost from the 13 predetermined types of modes. In this embodiment, the intra prediction mode selected here will be referred to as a “second intra prediction mode”. In this intra prediction, since only the encoding target block image and pixels adjacent to it are used, the circuit scale becomes smaller than that used in the intra TP motion prediction or inter prediction.

For an I picture, the intra prediction mode decision unit 207 compares, in step S309, the cost of the first intra prediction mode (intra TP motion prediction) output from the pattern matching unit 205 with the cost of the second intra prediction mode output from the intra prediction unit 206. The intra prediction mode decision unit 207 decides the mode of lower cost as the intra prediction mode. For a P or B picture, the intra prediction mode decision unit 207 directly decides the prediction mode output from the intra prediction unit 206 as the intra prediction mode.

In step S310, the intra/inter determination unit 208 finally decides the prediction mode. For an I picture, the intra/inter determination unit 208 directly decides the intra prediction mode output from the intra prediction mode decision unit 207 as the prediction mode. On the other hand, for a P or B picture, the intra/inter determination unit 208 compares the cost output from the pattern matching unit 205 with the cost output from the intra prediction mode decision unit 207, and decides the mode of lower cost as the prediction mode.

As described above, according to this embodiment, the pattern matching unit 205 normally used in the inter prediction mode is shared for the intra TP motion prediction in the intra prediction. More specifically, control is done to selectively use the pattern matching unit 205 in the inter prediction or in the intra TP motion prediction. Hence, since it is unnecessary to separately prepare the pattern matching circuit for the intra TP motion prediction, an increase in the circuit scale can be prevented.

### Second Embodiment

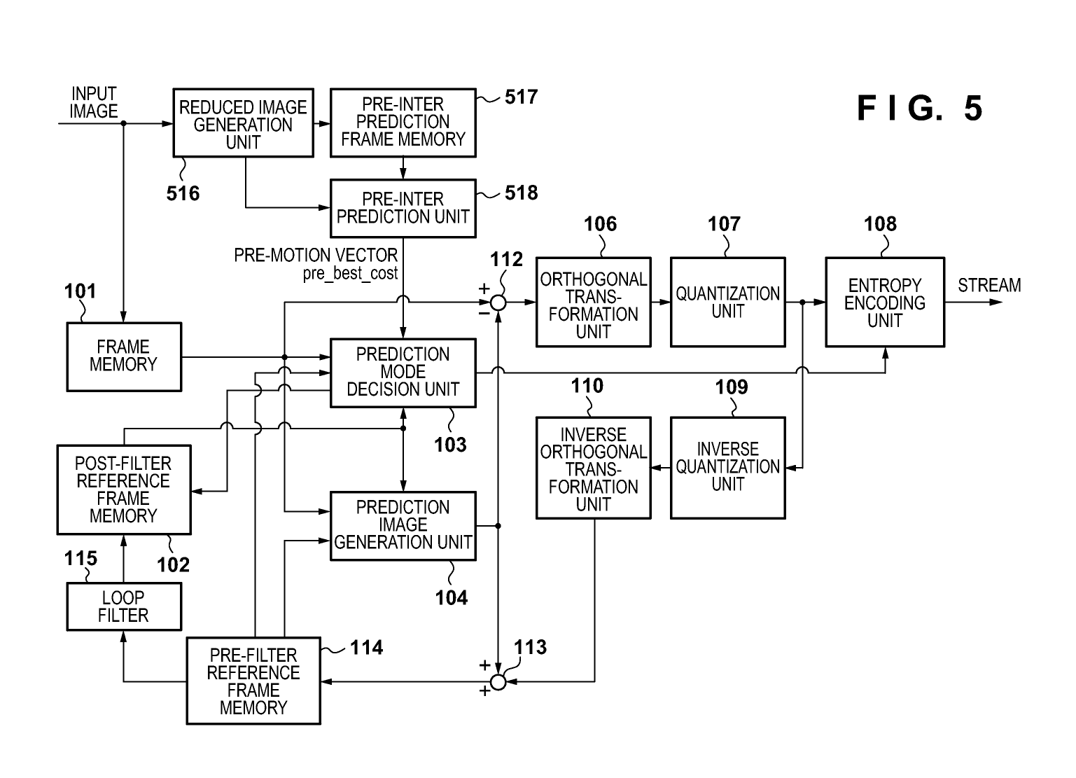

A moving image encoding apparatus according to the second embodiment will be described next in detail with reference to FIG. 5. The moving image encoding apparatus shown in FIG. 5 has almost the same structure as that of the moving image encoding apparatus according to the first embodiment shown in FIG. 1 except in including a reduced image generation unit 516, a pre-inter prediction frame memory 517, and a pre-inter prediction unit 518. The moving image encoding apparatus is also different in that a pre-motion vector search result of the pre-inter prediction unit 518 is output to a search range setting unit 203 in a prediction mode decision unit 103, and whether to perform intra TP motion prediction or inter prediction in a pattern matching unit 205 is switched. Note that the operations of the components other than the reduced image generation unit 516, the pre-inter prediction frame memory 517, the pre-inter prediction unit 518, and the search range setting unit 203 in the prediction mode decision unit 103 are the same as in the first embodiment, and a description thereof will be omitted.

The reduced image generation unit 516 generates the reduced image of an input image. As the method of generating the reduced image, for example, when reducing an image to ½ in the vertical direction and ¼ in the horizontal direction, the averages of the pixel values of two vertical pixels and four horizontal pixels are used. However, the method is not particularly limited. Note that in this embodiment, an example in which the image is reduced to ½ in the vertical direction and ¼ in the horizontal direction will be explained.

The pre-inter prediction frame memory 517 stores the reduced image of an input image from the reduced image generation unit 516 in the display order, and sequentially outputs an encoding target block to the pre-inter prediction unit 518 in the encoding order. The pre-inter prediction frame memory 517 also stores the reduced image of a progressive video as a pre-motion vector search reference image in pre-inter prediction, and sequentially outputs the pre-motion vector search reference image of the encoding target block to the pre-inter prediction unit 518. Note that since the pre-motion vector search is performed in the reduced image, the size of the encoding target block is adjusted accordingly. In this embodiment, the image is reduced to ½ in the vertical direction and ¼ in the horizontal direction. Hence, when the encoding target block has a size of 16×16, the pre-motion vector search is performed using a 4×8 block.

The pre-inter prediction unit 518 performs pattern matching processing between an encoding target block input from the pre-inter prediction frame memory 517 and a reference frame that is the generated reduced image output from the pre-inter prediction frame memory 517. In the pattern matching processing, a pre-motion vector indicating a position of high correlation is searched for. To estimate the motion vector having the maximum correlation, a cost function represented by equation (1) described above or the like can be used. A position where the calculated value of the cost function is minimum is selected as the pre-motion vector in the encoding target block. In addition, the cost at that time is output as pre_best_cost in the pre-motion vector search.

Note that since the pre-motion vector search reference image is performed using the reduced image, the size of the pre-motion vector needs to be adjusted to the image size when used by the prediction mode decision unit 103. In this embodiment, the detected pre-motion vector is enlarged fourfold in the horizontal direction and twofold in the vertical direction. Next, the decided pre-motion vector and pre_best_cost are output to the prediction mode decision unit 103.

The search range setting unit 203 in the prediction mode decision unit 103 sets the search range using pre_best_cost and the pre-motion vector output from the pre-inter prediction unit 518, and outputs the search range to a reference frame buffer 202.

If pre_best_cost is larger than a threshold Th (pre_best_cost>Th), the search range setting unit 203 sets a search range to be used in the intra TP motion prediction. On the other hand, if pre_best_cost is equal to or smaller than the threshold Th (pre_best_cost≦Th), the search range setting unit 203 sets a search range to be used in the inter prediction about the position indicated by the pre-motion vector. Th is a predetermined threshold.

The reason why the search range is set in this way will be described below. If pre_best_cost is larger than the threshold, the difference between frames is large, and efficient encoding cannot be performed even by inter prediction at a high possibility. Hence, to increase the encoding efficiency, the pattern matching unit 205 is used in the intra TP motion prediction without performing inter prediction. On the other hand, if pre_best_cost is equal to or smaller than the threshold, the difference between frames is small, and a sufficient encoding efficiency can be obtained by inter prediction at a high possibility. Hence, to increase the encoding efficiency, the pattern matching unit is used in the inter prediction.

As described above, the application purpose of the reference frame buffer 202 and the pattern matching unit 205 is switched in accordance with the value of pre_best_cost, thereby performing efficient encoding without affecting image quality. In addition, when the search range is switched based on pre_best_cost, the reference frame buffer 202 and the pattern matching unit 205 can be shared for the intra TP motion prediction and the inter prediction. This allows to largely reduce the circuit scale as compared to a case in which the circuits are separately implemented.

### Third Embodiment

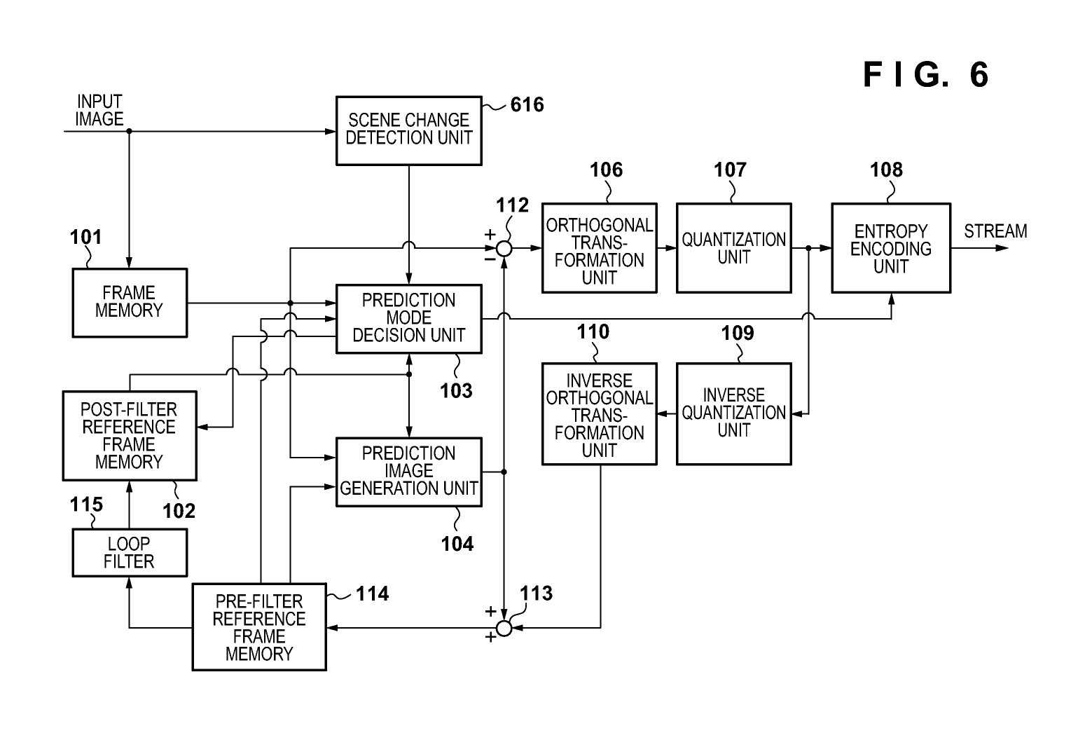

A moving image encoding apparatus according to the third embodiment will be described next in detail with reference to FIG. 6. The moving image encoding apparatus shown in FIG. 6 has almost the same structure as that of the moving image encoding apparatus according to the first embodiment shown in FIG. 1 except that a scene change detection unit 616 is included. The moving image encoding apparatus is also different in that the detection result of the scene change detection unit 616 is output to a search range setting unit 203 in a prediction mode decision unit 103, and whether to perform intra TP motion prediction or inter prediction in a pattern matching unit 205 is switched. Note that the operations of the components other than the scene change detection unit 616 and the search range setting unit 203 in the prediction mode decision unit 103 are the same as in the first embodiment, and a description thereof will be omitted in this embodiment.

The scene change detection unit 616 receives a moving image in the display order, detects the presence/absence of a scene change between an encoding target image and a reference image, and outputs the detection result to the prediction mode decision unit 103. The detailed method of scene change detection is not particularly limited. For example, the input image is delayed by a predetermined time via a frame delay unit, and the difference between the image the predetermined time before and the input image that is not delayed is calculated. If the difference is equal to or larger than a predetermined value, it can be determined that a scene change has occurred, considering that the correlation has become decreased.

In this embodiment, the search range setting unit 203 shown in FIG. 2 sets a search range using the scene change detection result output from the scene change detection unit 616, and notifies a reference frame buffer 202 of the search range. At this time, if a scene change is detected, the search range setting unit 203 sets a search range to be used in the intra TP motion prediction. On the other hand, if no scene change is detected, the search range setting unit 203 sets a search range to be used in the inter prediction.

The reason why the search range is set in this way will be described below. If a scene change has occurred, the possibility that the correlation between the reference frame and the encoding target frame becomes high is low, and efficient encoding cannot be performed. Hence, the pattern matching unit 205 is used in the intra TP motion prediction without performing inter prediction to increase the encoding efficiency. On the other hand, if no scene change has occurred, the possibility that the correlation between the reference frame and the encoding target frame becomes high is high, and efficient encoding can be performed by inter prediction. Hence, to increase the encoding efficiency, the pattern matching unit 205 is used in the inter prediction.

As described above, the application purpose of the reference frame buffer 202 and the pattern matching unit 205 is switched in accordance with the presence/absence of a scene change, thereby performing efficient encoding without affecting image quality. In addition, when the search range is switched based on the presence/absence of a scene change, the reference frame buffer 202 and the pattern matching unit 205 can be shared for the intra TP motion prediction and the inter prediction. This allows to largely reduce the circuit scale as compared to a case in which the circuits are separately implemented.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-259516, filed Nov. 28, 2011 which is hereby incorporated by reference herein in its entirety.

1. (canceled)

2. (canceled)

3. A moving image encoding apparatus for performing prediction encoding using inter prediction and intra prediction, comprising:
a storage unit configured to store an encoding target image;
a reference image storage unit configured to store a reference image for the prediction encoding;
a prediction mode decision unit configured to decide one of an inter prediction mode and an intra prediction mode as a prediction mode for a prediction target block in the encoding target image based on the encoding target image and the reference image; and
an encoding unit configured to perform the prediction encoding of the encoding target image in accordance with the decided prediction mode,
wherein said prediction mode decision unit comprising:
a search range setting unit configured to set a search range in the reference image;
a pattern matching unit configured to perform pattern matching using the encoding target image and the reference image read out based on the search range and searching for a region where a cost is minimum, said pattern matching unit calculating the cost as a cost of a first intra prediction mode using a first cost function according to a picture type that is I picture or calculating the cost as a cost of an inter prediction mode using a second cost function according to the picture type that is one of B picture and P picture;
an intra prediction unit configured to calculate the cost based on the first cost function for each of a plurality of predetermined intra prediction modes using the encoding target image and the reference image and deciding a second intra prediction mode for which the calculated cost is minimum;
an intra prediction mode decision unit configured to, when said pattern matching unit has calculated the cost of the first intra prediction mode, compare the cost with the cost of the second intra prediction mode decided by said intra prediction unit and deciding an intra prediction mode having a lower cost; and
a determination unit configured to, when said pattern matching unit has calculated the cost of the inter prediction mode, compare the cost with the cost of the second intra prediction mode decided by said intra prediction unit and determining a prediction mode having a lower cost,
wherein said encoding unit performs the prediction encoding in accordance with one of the intra prediction mode decided by said intra prediction mode decision unit and the prediction mode decided by said determination unit.

4. The apparatus according to claim 3, further comprising:
a generation unit configured to generate a reduced image of the encoding target image;
a reduced image storage unit configured to store the reduced image; and
a pre-inter prediction unit configured to perform pattern matching between the reduced image generated by said generation unit and the generated reduced image stored in said reduced image storage unit to calculate the cost based on the second cost function and calculating a motion vector based on a minimum cost,
wherein said search range setting unit sets a search range for the first intra prediction mode when the minimum cost is more than a threshold, and
sets a search range for the inter prediction mode based on the motion vector when the minimum cost is not more than the threshold, and
said pattern matching unit calculates the cost of the prediction mode according to the set search range.

5. The apparatus according to claim 3, further comprising a detection unit configured to detect a scene change by comparing the encoding target image with the encoding target image a predetermined time before,
wherein said search range setting unit sets a search range for the first intra prediction mode when the scene change has been detected, and
sets a search range for the inter prediction mode when the scene change has not been detected, and
said pattern matching unit calculates the cost of the prediction mode according to the set search range.

6. The apparatus according to claim 3, wherein the first cost function is one of SAD and SATD, and the second cost function is a function based on the SAD and a code amount of the motion vector in the inter prediction.

7. The apparatus according to claim 3, wherein when calculating the cost of the first intra prediction mode, said pattern matching unit calculates the cost using the first cost function based on pattern matching between a template region formed from encoded pixels adjacent to the encoding target image and the reference image read out based on the search range, and searches for a region where the cost is minimum.

8. (canceled)

9. (canceled)

10. A method of controlling a moving image encoding apparatus for performing prediction encoding using inter prediction and intra prediction, the moving image encoding apparatus including:
a storage unit configured to store an encoding target image;
a reference image storage unit configured to store a reference image for the prediction encoding;
a prediction mode decision unit configured to decide one of an inter prediction mode and an intra prediction mode as a prediction mode for a prediction target block in the encoding target image based on the encoding target image and the reference image; and
an encoding unit configured to perform the prediction encoding of the encoding target image in accordance with the decided prediction mode,
the method comprising steps of, by said prediction mode decision unit:
setting a search range in the reference image;
performing pattern matching using the encoding target image and the reference image read out based on the search range and searching for a region where a cost is minimum, and calculating the cost as a cost of a first intra prediction mode using a first cost function according to a picture type that is I picture or calculating the cost as a cost of an inter prediction mode using a second cost function according to the picture type that is one of B picture and P picture;
calculating the cost based on the first cost function for each of a plurality of predetermined intra prediction modes using the encoding target image and the reference image and deciding a second intra prediction mode for which the calculated cost is minimum;
when the cost of the first intra prediction mode has been calculated in the pattern matching, comparing the cost with the cost of the decided second intra prediction mode and deciding an intra prediction mode having a lower cost; and
when the cost of the inter prediction mode has been calculated in the pattern matching, comparing the cost with the cost of the decided second intra prediction mode and determining a prediction mode having a lower cost,
wherein the prediction encoding is performed by said encoding unit in accordance with one of the decided intra prediction mode and the determined prediction mode.

11. A non-transitory computer readable storage medium storing a program for controlling a moving image encoding apparatus for performing prediction encoding using inter prediction and intra prediction, the moving image encoding apparatus including:
a storage unit configured to store an encoding target image;
a reference image storage unit configured to store a reference image for the prediction encoding;
a prediction mode decision unit configured to decide one of an inter prediction mode and an intra prediction mode as a prediction mode for a prediction target block in the encoding target image based on the encoding target image and the reference image; and
an encoding unit configured to perform the prediction encoding of the encoding target image in accordance with the decided prediction mode,
the program causing said prediction mode decision unit to perform steps of:
setting a search range in the reference image;
performing pattern matching using the encoding target image and the reference image read out based on the search range and searching for a region where a cost is minimum, and calculating the cost as a cost of a first intra prediction mode using a first cost function according to a picture type that is I picture or calculating the cost as a cost of an inter prediction mode using a second cost function according to the picture type that is one of B picture and P picture;
calculating the cost based on the first cost function for each of a plurality of predetermined intra prediction modes using the encoding target image and the reference image and deciding a second intra prediction mode for which the calculated cost is minimum;
when the cost of the first intra prediction mode has been calculated in the pattern matching, comparing the cost with the cost of the decided second intra prediction mode and deciding an intra prediction mode having a lower cost; and
when the cost of the inter prediction mode has been calculated in the pattern matching, comparing the cost with the cost of the decided second intra prediction mode and determining a prediction mode having a lower cost,
wherein the prediction encoding is performed by said encoding unit in accordance with one of the decided intra prediction mode and the determined prediction mode.
